(19) United States
(12) Patent Application Publication
(10) Pub. No.: US 2008/0259597 A1
(43) Pub. Date: Oct. 23, 2008

(54) Lighting Fixture Adapter

(75) Inventors: Timothy E. Safford, Bradenton, FL (US); David C. Miller, Tampa, FL (US); Eric Bretschneider, Clarkston, MI (US); Randolph Scott Beemann, Sarasota, FL (US); David M. Chism, Bradenton, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(73) Assignee: BEEMAN HOLDINGS, INC., SARASOTA, FL (US)

(21) Appl. No.: 11/573,700

(22) PCT Filed: Apr. 25, 2005
(86) PCT No.: PCT/US2005/014061

§ 371 Date: Jan. 31, 2008

Related U.S. Application Data
(60) Provisional application No. 60/565,113, filed on Apr. 23, 2004.

(51) Int. Cl. F21V 9/00; F21V 23/04

(52) U.S. Cl. 362/231; 362/251

(57) ABSTRACT

A method of adapting an existing lighting fixture to provide selectively-energizable, turtle-friendly lighting includes interposing an adapter between a lighting fixture and an electrical box, providing a light source in the adapter and coupling an electrical power source to the adapter for selectively energizing either the light source or the lighting fixture.

### BACKGROUND

Turtles nest on beaches. When a turtle's egg hatches, the hatchling needs to crawl from the beach into the ocean. However, certain types of beachfront lighting, such as incandescent or fluorescent lighting, seem to distract the hatchlings from reaching the ocean. If the hatchling fails to reach the ocean in a given amount of time it may die. Beachfront lighting also appears to discourage female turtles from coming ashore to nest.

Some communities have adopted laws to alter beachfront lighting during turtle nesting and hatching season. Florida, for example, has mandated that beachfront lighting be turned off or blacked out during nesting season. Adhering to this mandate can present a potentially hazardous condition for pedestrians trying to negotiate dark walkways near the beach at night.

Beachfront lighting fixtures can include incandescent or fluorescent light bulbs, which emit light that appears to be particularly disruptive to the nesting and hatching of turtles.

### SUMMARY OF THE INVENTION

One aspect features a method of adapting an existing lighting fixture to provide selectively-energizable, turtle-friendly lighting. This method includes interposing an adapter between a lighting fixture and an electrical box, providing a light source in the adapter and coupling an electrical power source to the adapter for selectively energizing either the light source or the lighting fixture.

In one implementation, the light source emits a light that is substantially not visible to a turtle. According to another implementation, the light source emits a substantially monochromatic light that may be, for example, red, orange or yellow. In certain instances, the light source may be a light emitting diode. Generally, the term “light emitting diode” includes, inter alia, a semiconductor pn junction that emits coherent or incoherent light when forward biased. Additionally, the term “light emitting diode” includes laser diodes. According to another embodiment, the light source may be a fluorescent lamp with a red filter. In another embodiment, the light source may be a red neon lamp. Additionally, the light source may emit a light substantially composed of wavelengths between approximately 590 nanometers and 650 nanometers.

In certain embodiments, the method includes permitting the emitted light to radiate from the adapter in a predetermined direction.

Another aspect includes a method of adapting a lighting fixture to selectively provide turtle-friendly lighting. This method includes decoupling a lighting fixture from a mounting base, coupling an adapter to the mounting base, and coupling the lighting fixture to the adapter. The adapter includes a housing unit adapted to receive and selectively energize either the lighting fixture or a selectively-energizable, substantially monochromatic light source associated with the housing.

In one implementation, the light source emits a light that is substantially not visible to a turtle. According to a particular embodiment, the light source emits a red or yellow light. In certain instances, the light source may be a light emitting diode or a neon lamp. Additionally, the light source may emit a light substantially composed of wavelengths between approximately 590 nanometers and 650 nanometers.

According to one embodiment, the method includes directing light emitted from the light source in a predetermined direction.

Yet another aspect includes a lighting fixture adapter having a housing unit adapted to receive a lighting fixture and an opening to receive an electrical power source. A substantially monochromatic light source is associated with the housing unit and a switch to selectively couple the electrical power source either to the light source or to a lighting fixture mounted on the adapter.

A certain embodiment includes a light source that is substantially not visible to a turtle. In some instances, the light source emits a red or yellow light. Moreover, light emitted from the light source may have a wavelength that is between approximately 590 nanometers and 650 nanometers. In certain embodiments, the light source may be either a light emitting diode or a neon lamp.

Particular embodiments include a deflector to direct the transmission of light from the light source in a predetermined direction.

In some implementations one or more of the following advantages may be present. Existing lighting fixtures may be easily adapted to incorporate provisions for turtle-friendly lighting. Adapting a lighting fixture in this manner may be accomplished without significantly affecting the physical profile, dimensions, style or overall aesthetic appeal of an existing lighting fixture. Additionally, the turtle friendly light provided by an adapted lighting fixture may provide a sufficient level illumination to permit humans to see, while, at the same time, not significantly distract the nesting habits of a local turtle population.

Other features and advantages will be readily apparent from the following detailed description, the accompanying drawings and the claims.

### BRIEF DESCRIPTION OF THE DRAWINGS

FIG. 1 is a flow diagram.

FIG. 2 is an exploded view of an adapter installation.

FIG. 3A is a perspective view of a lighting fixture attached to a wall.

FIG. 3B is a perspective view of a lighting fixture and an adapter attached to a wall.

FIGS. 4A and 4B are partial cross-sections of an adapter.

FIGS. 5A and 5B are circuit diagrams for selectively energizing an incandescent light bulb and light emitting diodes.

Like reference symbols in the various drawings indicate like elements.

### DETAILED DESCRIPTION OF THE DRAWINGS

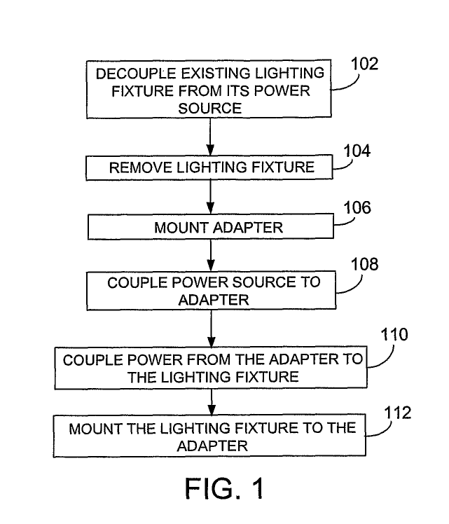

FIG. 1 is a flow diagram detailing a method of adapting an existing lighting fixture to provide a lighting option that is generally less disruptive to the nesting habits of turtles. The method is particularly suitable for adapting outdoor-type lighting fixtures, such as are typically installed at beachfront properties including hotels, private residences and public venues.

Traditional lighting fixtures can include one or more incandescent or fluorescent light bulbs and mounting provisions to attach the fixture to some surface. A shade arrangement also may be included. Lighting fixtures can be mounted to an electrical box positioned inside a wall, ceiling, pole, or other support structure.

The illustrated method includes decoupling 102 an existing lighting fixture from its power source. This may be accomplished, for example, by electrically opening the circuit that is arranged to feed power to the lighting fixture, gaining access to the electrical conductors that are adapted to carry power to the lighting fixture and disconnecting those electrical conductors from the lighting fixture. Such electrical conductors could be disconnected, for example, at an electrical box to which the lighting fixture is mounted.

The method also includes removing 104 the lighting fixture from its mounting base. The mounting base may be part of an electrical box. Removing 104 the lighting fixture can entail removing hardware that fastens the lighting fixture to its mounting base and dislodging the lighting fixture from its mounting base. After dislodging the existing lighting fixture from its base, the lighting fixture may be temporarily set aside.

Next, the method includes mounting 106 an adapter to the mounting base. The adapter includes a selectively-energizable, substantially-monochromatic light source and provisions for receiving and selectively energizing the previously-removed lighting fixture.

According to one embodiment, the light source in the adapter is a turtle-friendly light. The term “turtle-friendly” refers to light sources that are substantially not visible to a turtle or substantially non-offensive to a turtle. “Turtle-friendly” includes, red, orange or yellow light emitting diodes (including laser diodes), low pressure sodium lamps, and neon lamps. “Turtle-friendly” lights may emit a light having a wavelength of greater than approximately 590 nanometers, more preferably, having a wavelength that is between approximately 590 nanometers and 650 nanometers, and, most preferably, having a wavelength of between approximately 640 nanometers and 650 nanometers. “Turtle-friendly” lights are typically visible to humans.

The illustrated method further includes coupling 108 the power source to the adapter. Typically, this would include electrically connecting the adapter to electrical conductors from the power supply in the electrical box from which the lighting fixture had been previously removed.

Furthermore, the method includes coupling 110 power from the adapter to the previously-removed lighting fixture for selective energizing.

Finally, the method includes mounting 112 the previously-removed lighting fixture to the adapter.

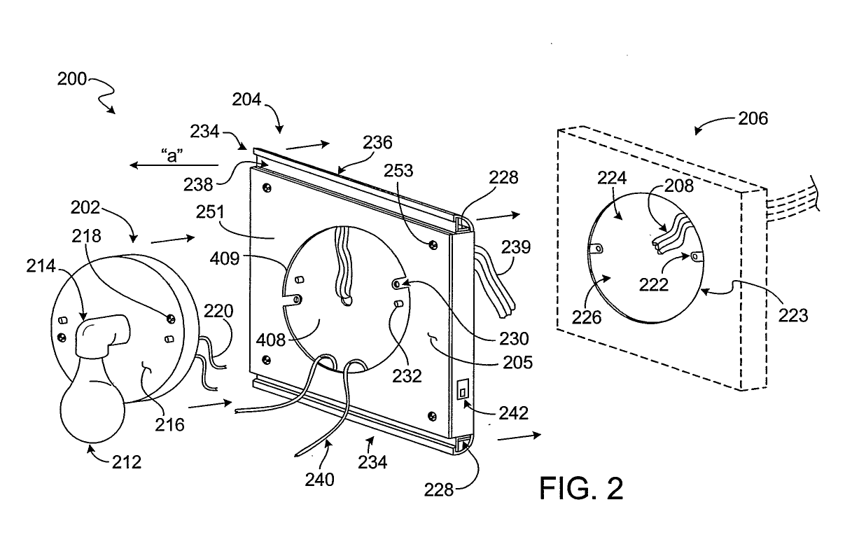

FIG. 2 is an exploded view detailing a particular embodiment of a turtle-friendly lighting adapter installation 200 that includes a lighting fixture 202, an adapter 204, and an electrical box 206. The electrical box 206 and associated elements are illustrated with dashed lines to indicate their position inside a wall (wall not shown). In one implementation, a hole in the wall may permit access to the electrical box 206 and to electrical conductors 208 within the electrical box 206. The electrical conductors 208 within the electrical box 206 are adapted to carry power to the electrical box from a remote power source (power source not shown).

The lighting fixture 202 includes an incandescent light bulb 212, a support member 214 for the light bulb 212, and a base unit 216. Alternatively, the lighting fixture 202 could include, for example, a compact fluorescent bulb (not shown). Fastening hardware includes two screws 218 adapted to mate with mounting tabs 230 on the adapter 204. Electrical conductors 220 are exposed at a rear surface of the lighting fixture 202 and are adapted to be connected to a power source. According to certain embodiments, the lighting fixture 202 may include, for example, several bulbs arranged in any number of ways, shading, switching provisions for turning the light(s) on or off, as well as other ornamental and functional elements.

The electrical box 206 defines a mounting base 223 for receiving a lighting fixture (e.g., lighting fixture 202) or other device (e.g., adapter 204). The mounting base 223 includes two mounting tabs 222. The electrical box 206 is largely hollow and includes an internal cavity 224 that is accessible through a hole 226 in the box 206. As previously mentioned, a typical installation may include a hole in the wall substantially aligned with the hole 226 in the box to allow access to the internal cavity 224 of the electrical box.

Electrical conductors 208 are adapted to carry power from a remote power source to the electrical box 206. The electrical conductors 208 can be attached to a device (e.g., lighting fixture 202 or adapter 204) that is mounted to the electrical box and positioned outside the wall. In the illustrated embodiment, the electrical conductors 208 are adapted to be connected to electrical conductors 239 of the adapter 204 and to deliver power thereto.

The adapter 204 is interposed between the lighting fixture 202 and the electrical box 206. The adapter 204 includes a housing unit 205, a lens assembly 234 positioned proximate a top surface of the housing unit 205 and a lens assembly 234 positioned proximate a bottom surface of the housing unit 205.

The housing unit 205 defines a splice area 408 within which electrical conductors 240 may be spliced to electrical conductors 220 of the lighting fixture 202. An opening 409 in the housing unit 205 can provide access to the splice area 408.

The housing unit 205 is adapted to be mounted on the mounting base 223 of the electrical box 206. The adapter 204 can be secured to the mounting base 222 using standard mounting hardware 232 that mates with mounting tabs 222.

The adapter 204 is configured to receive the lighting fixture 202. Specifically, the adapter 204 includes mounting tabs 230 to receive hardware 218 for securing the lighting fixture 202 to the adapter 204. An optional gasket seal 251 is positioned between the adapter 204 and the lighting fixture 202 and is fastened to the adapter 204 with hardware 253.

Each lens assembly 234 includes a lens 236, a light source 228, and a deflector 238. Each lens 236 can be a substantially translucent material to permit a substantial amount of light emitted from the light source 228 to pass through. The side surfaces 404 of the lens assembly may include substantially translucent material, substantially opaque material or may be open.

Each deflector 238 can be a substantially opaque material that can restrict or inhibit the passage of light from the light source 228 through it. According to the embodiment illustrated, the deflector 238 is positioned to inhibit or restrict the transmission of light from the light source 228 approximately in a direction indicated by arrow “a.” Specifically, light is inhibited or restricted from being transmitted in a direction that is perpendicular to a plane defined approximately by a surface of the adapter 204 that mates with the lighting fixture 202.

A number of deflector 238 arrangements are possible. Generally, however, a deflector 238 may be positioned relative to a light source 228 in such a manner as to direct light that is emitted from the light source in a predetermined direction. This predetermined direction typically may be away from where a turtle's nesting area is located.

The lens 236 can permit the transmission of light from the light source 228 in multiple directions that range from approximately straight up or down to a direction that is approximately opposite the direction indicated by arrow “a.” Accordingly, some of the light emitted from the light source 228 might be reflected off the wall (not illustrated) proximate the adapter 204. According to certain embodiments, however, the lens assembly 204 may include additional deflectors to further restrict or inhibit the transmission of light from the light source 228 onto the wall proximate the adapter 204.

According to a particular embodiment, the light source 228 in the adapter 204 is a turtle-friendly light.

Electrical conductors 239 are exposed at a back surface of the adapter 204. Those conductors 239 are adapted to be connected to the electrical conductors 208 that are located at least partially within the electrical box 206 and can extend outwardly therefrom.

Another set of electrical conductors 240 extends from the splice area 408 of the housing unit 205. Those electrical conductors 240 are adapted to be connected to the electrical conductors 220 of the lighting fixture 202 and to selectively deliver power thereto.

A switch 242 is positioned on the adapter 204. The switch is selectively positionable to energize either the light sources 228, the light bulb 212 of the lighting fixture 202, neither, or, perhaps, both. According to certain embodiments, the switch 204 may be positioned entirely within the housing unit 205 of the adapter 204. According to such an arrangement, manually changing the switch's 242 position would not be possible. However, the switch 242 may include provisions for magnetic actuation, such that the switch's position may be changed, for example, by passing a magnet through an area that is proximate the adapter 204. The switch 242 could include, for example, a magnetic reed switch and a relay.

According to certain embodiments, the following elements may be included inside the housing 204: a transformer (not shown), a rectifier (not shown), switches (not shown) and other control circuitry to support adapter 204 operations. Operationally, once installed, the adapter 204 would provide a means of selectively energizing either the lighting fixture 202 or the light sources 228.

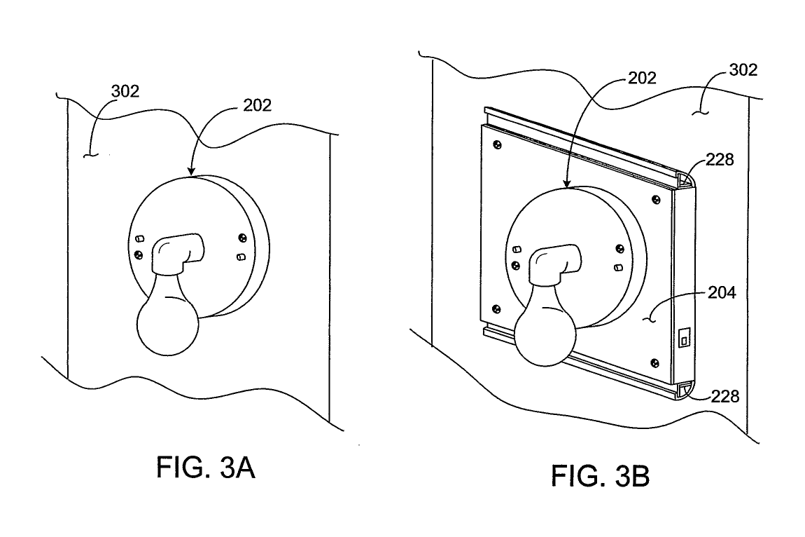

FIG. 3A illustrates a lighting fixture 202 secured directly to a wall 302. FIG. 3B illustrates the same lighting fixture 202 adapted for turtle friendly lighting. Particularly, in FIG. 3B, an adapter 204 with turtle-friendly light sources 228 is interposed between the lighting fixture 202 and the wall 302.

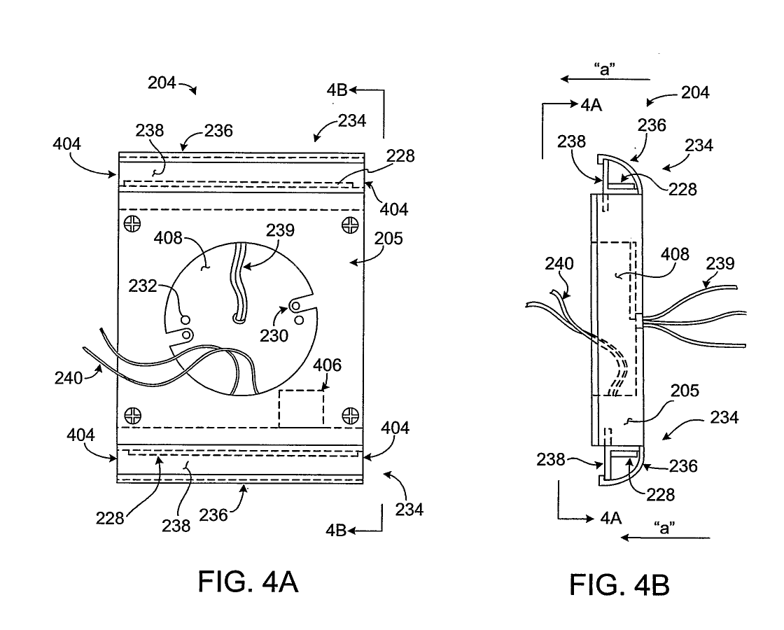

FIGS. 4A and 4B illustrate partial sectional views of an adapter 204 that includes a housing unit 205 and two lens assemblies 234 positioned proximate a top surface and a bottom surface of the housing unit 205. The housing unit 205 includes provisions for receiving a lighting fixture. Specifically, mounting tabs 230 are provided.

Deflectors 238 are positioned to inhibit or restrict the transmission of light from the light source 228 in a direction indicated by arrow “a” (see FIG. 4B only). Each deflector 238 is approximately “T” shaped and is supported by being at least partially extended into the housing unit 205. Light sources 228 are positioned proximate one leg of each deflector 238. In some implementations, an inner surface of each deflector (i.e., each vertical surface that faces a light source 228) will possess a reflective property.

A number of possible deflector 238 configurations are possible. For example, the deflector 238 could form a channel that partially encloses the light source 228. In such an instance a cross-section of the deflector 238 can be, for example, parabolic, elliptical, semi-circular, or hyperbolic. In each instance, an internal surface of the deflector 238 may possess a reflective quality.

The lenses 236 permit light from the light sources 228 to pass in a direction ranging from approximately straight up or down to a direction that is approximately opposite the direction indicated by arrow “a.” Accordingly, some of the light emitted from the light source 228 may be reflected off a wall (not illustrated) proximate the adapter 204. In certain embodiments, however, the lens assembly 204 may include additional deflectors to further restrict or inhibit the transmission of light from the light source 228 onto the wall (not shown) proximate the adapter 204. Light from the light source 228 may also pass through the sides 404 (see FIG. 4A only) of each lens assembly 234.

In certain instances, the space between the light source 228, the lens 238 and the vertical portion of the deflector 238 is at least partially filled with a protective material. This protective material may be, for example, a transparent epoxy, acrylic or silicon substance. The protective material will preferably be highly transparent to light emitted by the light source 228 and be capable of providing some degree of physical protection to the light source 228.

The adapter 204 also includes an internal cavity 406 within the housing unit 205. In certain embodiments, the internal cavity 406 contains various circuit elements to support the operational aspects of the adapter 204. These circuit elements may include, for example, transformers, switches, rectifier assemblies, and various other control circuitry.

Electrical conductors 239 extend from the internal cavity 406 through a back surface of the housing unit 205. Those electrical conductors 239 are exposed proximate the back surface of the housing unit 205 and are adapted to be connected to a remote power source (not shown). Particularly, the conductors 239 pass through a small hole in the back surface of the housing unit 205. The electrical conductors 205 are adapted to carry power from the power source to the operational support circuitry contained within the internal cavity 406 of the housing unit 205.

A splice area 408 provides access to a second set of electrical conductors 240 that are adapted to be connected to a lighting fixture 202. The splice area 408 is typically sized in a manner to facilitate attaching electrical conductors from the lighting fixture 202 to the illustrated electrical conductors 240.

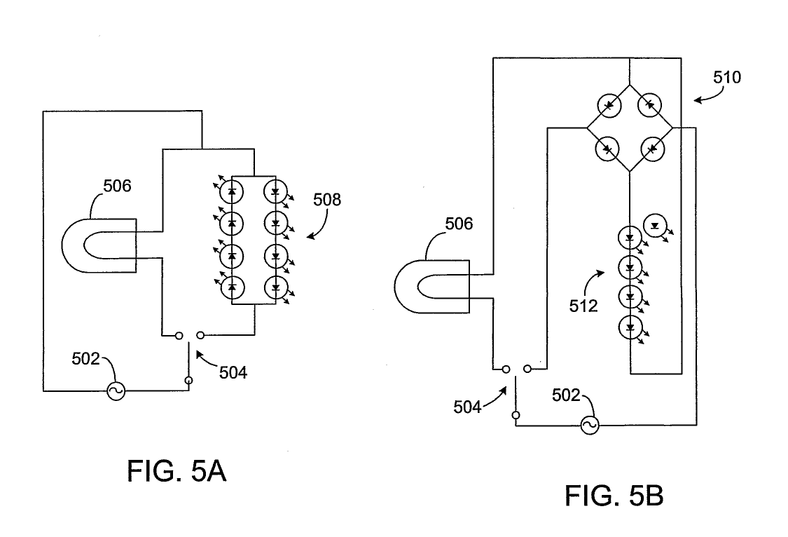

FIGS. 5A and 5B illustrate exemplary circuit designs that may be utilized to selectively energize either an incandescent light bulb or a light emitting diode (or diodes).

FIG. 5A illustrates an incandescent bulb 506 and parallel strings of light emitting diodes 508, each string having an opposite polarity. A power source 502 is electrically coupled to a multi-positional switch 504. Depending on the switch's position, power from the power source 502 may be selectively delivered to either the incandescent bulb 506 or the light emitting diodes 508.

Referring now to FIG. 5B, a power source 502 is connected to a multi-positional switch 504 to selectively energize either an incandescent bulb 506 or a string of light emitting diodes 512. The string of light emitting diodes is arranged in series, each diode having the same relative polarity. A full-wave rectifier 510 is adapted to supply rectified power to the light emitting diodes 512. In certain embodiments, the full-wave rectifier 510 will be excluded from the circuit design.

A number of implementations of the invention have been described. Nevertheless, it will be understood that various modifications and applications of the concepts described herein may be made without departing from the spirit and scope of the invention. For example, the physical arrangement of light emitting diodes and deflectors may be significantly varied. Also, the shape and style of the adapter may be modified. Additionally, a number of circuitry designs may be suitable for use in implementing the functional aspects associated with the adapter described herein. Moreover, the order of steps indicated in the flow diagram of FIG. 1 may be modified in a number of ways. Accordingly, other implementations are within the scope of the following claims.

What is claimed is:

1. A method comprising:
interposing an adapter between a lighting fixture and an electrical box;
providing a light source in the adapter; and
coupling an electrical power source to the adapter for selectively energizing either the light source or the lighting fixture.

2. The method of claim 1 wherein the light source emits a light that is substantially monochromatic.

3. The method of claim 2 wherein the light source emits a red light, an orange light or a yellow light.

4. The method of claim 1 further comprising permitting the light to radiate from the adapter in a predetermined direction.

5. The method of claim 1 wherein the light source comprises a light emitting diode.

6. The method of claim 1 wherein the light source comprises a neon lamp.

7. A method of adapting a lighting fixture to selectively provide turtle-friendly lighting, the method comprising:
decoupling a lighting fixture from a mounting base;
coupling an adapter to the mounting base, the adapter comprising:
a housing unit adapted to receive and selectively energize the lighting fixture; and
a selectively-energizable, substantially monochromatic light source that emits a light that is not visible to a turtle associated with the housing unit; and
coupling the lighting fixture to the adapter.

8. The method of claim 7 wherein the light source emits a red light, an orange light or a yellow light.

9. The method of claim 7 wherein the light source emits a light having a wavelength that is between approximately 590 nanometers and 650 nanometers.

10. The method of claim 9 further comprising directing light emitted from the light source in a predetermined direction.

11. A lighting fixture adapter comprising:
a housing unit having a front face adapted to receive a lighting fixture and having an opening to receive an electrical power source;
a substantially monochromatic light source associated with the housing; and
a switch to selectively couple the electrical power source either to the light source or to a lighting fixture mounted on the adapter.

12. The lighting fixture adapter of claim 11 wherein the light source emits a light that is substantially not visible to a turtle.

13. The lighting fixture adapter of claim 11 wherein the light source emits a red light, an orange light or a yellow light.

14. The lighting fixture adapter of claim 11 wherein the light source emits a light having a wavelength that is between approximately 590 and 650 nanometers.

15. The lighting fixture adapter of claim 11 comprising a deflector to direct the transmission of light from the light source in a predetermined direction.

16. The lighting fixture adapter of claim 11 wherein the light source comprises a light emitting diode.

17. The lighting fixture adaptor of claim 16 wherein the light source includes at least one diode string.

18. The lighting fixture adaptor of claim 11 that does not directly transmit light from the light source perpendicularly to said front face.

19. The lighting fixture adaptor of claim 11 wherein said switch is located inside said housing.

20. The lighting fixture adapter of claim 11 wherein the light source comprises a neon lamp.
